(19) United States
(12) Patent Application Publication
(10) Pub. No.: US 2003/0205570 A1
(43) Pub. Date: Nov. 6, 2003

(54) Cooktop having a weighing unit

(76) Inventor: Dan Neumayer, Bernau (DE)

Correspondence Address: LERNER AND GREENBERG, P.A., POST OFFICE BOX 2480, HOLLYWOOD, FL, 33022-2480, US

(21) Appl. No.: 10/391,987

(22) Filed: Mar. 19, 2003

Related U.S. Application Data
(63) Continuation of application No. PCT/EP01/10828, filed on Sep. 19, 2001.

(30) Foreign Application Priority Data
Sep. 19, 2000 (DE) 100 46 348.7

(51) Int. Cl. H05B 3/68

(52) U.S. Cl. 219/447.1; 219/518

(57) ABSTRACT

A cooktop includes a cooktop panel, in particular, of glass ceramic material, associated with at least one heating element for heating a cooking vessel that can be set down on the cooktop panel and a weighing unit having a detection unit through which it is possible to determine a deformation of the cooktop panel as a result of weight-induced loading. The cooktop panel has a defined subregion, and the detection unit can sense lowering of the subregion as a result of weight-induced loading.

### CROSS-REFERENCE TO RELATED APPLICATION

This application is a continuation of copending International Application No. PCT/EP01/10828, filed Sep. 19, 2001, which designated the United States and was not published in English.

### BACKGROUND OF THE INVENTION

Field of the Invention

The invention is based on a cooktop or hob having a weighing unit that has a detection unit through which it is possible to determine a deformation of the cooktop panel as a result of weight-induced loading.

A similar cooktop is disclosed in International Application WO 95/35483, the cooktop having an uninterrupted surface panel with at least one heatable cooking point and a frame. This frame can be supported on a stationary or transportable support, for example, a prior art work top with cooktop cut-out.

The cooktop has at least one sensor, which is disposed between the surface panel and the frame or between the frame and the support. The sensor is, preferably, a pressure or force sensor or a displacement sensor combined with a deformable bearing part. Alternatively, it is also possible for the sensor to be a deformation sensor and to be fitted on the surface panel itself, in particular, on the underside of the latter in the border region of the surface panel. The disadvantage of such a configuration is a measuring inaccuracy brought about by the measured value sensed being dependent on a bearing surface of a cooking vessel set down on the cooktop. The larger the bearing surface of the cooking vessel, the smaller the deformation and, thus, the measured value.

### SUMMARY OF THE INVENTION

It is accordingly an object of the invention to provide a cooktop having a cooktop panel, in particular, of glass ceramic material, the cooktop having at least one heating element for heating a cooking vessel that can be set down on the cooktop panel and having a weighing unit with a detection unit through which it is possible to determine a deformation of the cooktop panel as a result of weight-induced loading that overcomes the hereinafore-mentioned disadvantages of the heretofore-known devices and methods of this general type and that, along with a straightforward construction, allows a high level of measuring accuracy in respect of the weighing function.

With the foregoing and other objects in view, there is provided, in accordance with the invention, a cooktop including a cooktop panel having a defined subregion, at least one heating element disposed at the cooktop panel for heating a cooking vessel to be set down on the cooktop panel and apply a weight-induced loading on the cooktop panel, and a weighing unit having a detection unit disposed at the cooktop panel and determining a deformation of the cooktop panel by sensing a lowering of the subregion as a result of the weight-induced loading.

The invention is based on a cooktop having a cooktop panel, in particular, made of glass ceramic material, the underside of which has at least one heating element for heating a cooking vessel that can be set down on the cooktop panel, and having a weighing unit that has a detection unit through which it is possible to determine a deformation of the cooktop panel as a result of weight-induced loading.

The cooktop panel has a defined subregion, and the detection unit can sense lowering of the subregion as a result of weight-induced loading. It is possible to achieve a weight measurement regardless of the size of a bearing surface of a cooking vessel, to be precise, always by a lowering action of the entire subregion being sensed. Furthermore, it is possible to achieve precise measured values even if a cooking vessel is set down eccentrically on the subregion.

The subregion may be defined by various possible measures that appear expedient to the person skilled in the art, for example, by a stiffened, planar region in the cooktop panel. However, the subregion is particularly advantageously defined by at least one elevation. The elevation may be achieved straightforwardly in design terms and, in particular, cooking vessels with a larger diameter than the elevation itself may be set down on the elevation without the cooking vessel, thus, ending up resting outside the defined subregion, which would result in a measuring error. Stiffening may be achieved by way of a border region of the elevation, with the result that bending of the subregion, which is advantageously small in relation to the overall surface area of the cooktop, is negligible. It is also possible, however, for the subregion to be stiffened additionally despite an elevation, for example, by a greater material thickness and/or by an additional component.

Furthermore, the elevation may, advantageously, be utilized as a weighing marking and as an indicator of a cooktop with a weighing unit. The subregion, here, is advantageously formed by an individual elevation. As a result, it is possible to avoid additional borders and, thus, locations that are susceptible to contamination. It is also possible, however, for the subregion to be formed by a plurality of elevations and to be defined by a plurality of points or surface areas. The individual elevations here may have different shapes that appear expedient to the person skilled in the art, for example, they may be of kidney-shaped, elliptical, round, polygonal, etc. configuration.

If the elevation is integrally formed on the cooktop panel, it is possible to do away with additional components and assembly outlay. Furthermore, the production of the elevation may be integrated cost-effectively in the production process of the cooktop panel, to be precise, in particular, by the cooktop panel being positioned on a surface with a corresponding contour and the elevation being integrally formed on the cooktop panel by the weight of the cooktop panel. It is possible here for the cooktop panel to be positioned on the surface in a still free-flowing state, or to be converted into a free-flowing state by being heated in a furnace. To be able to utilize a large part of the weight of the cooktop panel as far as possible, the cooktop panel is, advantageously, positioned by way of its underside on a surface with a corresponding elevation, which, then, forms the region-defining elevation on the top side of the cooktop panel.

Alternatively, however, it is also possible for the elevation to be formed by one or more components fastened on the cooktop panel. As a result, in particular, standard cooktop panels may be used and, in addition, retrofitting is easily possible. Furthermore, advantageous stiffening of the subregion may be achieved by way of an additional component. The components may be connected in a force-fitting, form-fitting, and/or integral manner to the cooktop panel, for example, by adhesive bonding, screw connection, clamping connection, etc. A form-locking or form-fitting connection is one that connects two elements together due to the shape of the elements themselves, as opposed to a force-locking or force-fitting connection, which locks the elements together by force external to the elements.

In order for thermal stresses between the additional component or the additional components and the cooktop panel to be avoided as far as possible, the components and the cooktop panel should have at least similar coefficients of thermal expansion. It is particularly advantageous for the additional components and the cooktop panel to be produced from the same material, for example, from glass ceramic material.

The subregion may have different shapes, for example, it may be of elliptical, polygonal, etc. configuration. However, it is particularly advantageously of round configuration. As a result, advantageous force introduction is achieved and the subregion can be integrated in an aesthetically pleasing manner between cooking points.

If the elevation has a height of between 0.2 mm and 5 mm, and, particularly advantageously, a height of 1 mm, it is possible, on one hand, for the elevation to be integrally formed in a particularly favorable manner on a cooktop panel made of glass ceramic material and, on the other hand, for a cooking vessel to be pushed onto the subregion without it having to be raised to any significant extent. If the elevation has a run-out radius of between 20 mm and 100 mm, and, particularly advantageously, a run-out radius of 60 mm, tilting of the cooking vessel may be avoided when the latter is drawn onto the subregion, and it is possible to avoid cooking points in the cooktop panel from being influenced.

Furthermore, the subregion is advantageously between 78 cm² and 255 cm², and, particularly advantageously, 165 cm². In the case of a round subregion, this corresponds to a diameter of between approximately 100 mm and 180 mm, and, advantageously, a diameter of approximately 145 mm. The subregion may, thus, be integrated in a space-saving manner between cooking points of the cooktop panel, advantageous lowering of the subregion to a great extent, which is, thus, easy to sense, can be achieved on account of high surface pressure and/or concentrated force introduction and, in addition, large cooking vessels can be reliably set down on the subregion without tipping over. In addition to subregions with the specified heights, run-out radii, and surface areas, other subregions with differing dimensions are, of course, also conceivable in principle.

With the objects of the invention in view, in a cooktop having a cooktop panel with a defined subregion and at least one heating element disposed at the cooktop panel for heating a cooking vessel to be set down thereon and apply a weight-induced loading thereon, there is also provided a weighing unit including a detection unit disposed at the cooktop panel and determining a deformation of the cooktop panel by sensing a lowering of the subregion as a result of the weight-induced loading.

With the objects of the invention in view, there is also provided a process for producing a cooktop, including the steps of providing a cooktop panel to be formed with at least one integral elevation having a desired contour, the at least one integral elevation defining a subregion, the cooktop panel having a weight, providing a surface with a contour corresponding to the desired contour, positioning the cooktop panel on the surface and forming the at least one integral elevation on the cooktop panel by the weight of the cooktop panel, disposing at least one heating element at the cooktop panel for heating a cooking vessel to be set down on the cooktop panel and to apply a weight-induced loading on the cooktop panel, and disposing a weighing unit having a detection unit at the cooktop panel and determining a deformation of the cooktop panel with the detection unit by sensing a lowering of the subregion as a result of the weight-induced loading.

With the objects of the invention in view, there is also provided a process for producing a cooktop, including the steps of providing a surface with a contour corresponding to a desired contour of the at least one integral elevation and forming the at least one integral elevation on the cooktop panel by positioning the cooktop panel on the surface to form the at least one integral elevation by the weight of the cooktop panel.

In accordance with another mode of the invention, the positioning and forming step is carried out by positioning an underside of the cooktop panel on the contour of the surface.

In accordance with a further mode of the invention, the positioning and forming step is carried out by positioning an underside of the cooktop panel on the contour of the surface and then heating at least the cooktop panel.

In accordance with an added mode of the invention, the heating step is carried out by heating at least the cooktop panel until the cooktop panel is at least partially converted into a free-flowing state.

In accordance with an additional mode of the invention, the converting and forming steps are carried out by at least partially converting the subregion of the cooktop panel into the free-flowing state and adapting the subregion to the contour of the surface to form the at least one elevation during the free-flowing state based upon the weight of the cooktop panel. Preferably, the at least one elevation is formed during the free-flowing state based only upon the weight of the cooktop panel.

In accordance with a concomitant mode of the invention, the at least one elevation is formed on a top side of the cooktop panel.

Further advantages can be gathered from the following description of the drawings. An exemplary embodiment of the invention is illustrated in the drawings. The drawings, the description and the claims contain numerous features in combination. The person skilled in the art will also expediently consider the features individually and combine them to form expedient further combinations.

Other features that are considered as characteristic for the invention are set forth in the appended claims.

Although the invention is illustrated and described herein as embodied in a cooktop having a weighing unit, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, plan view of a simplified detail of a cooktop according to the invention;

FIG. 2 is a fragmentary, cross-sectional view along line II-II of FIG. 1; and

FIG. 3 is a fragmentary, cross-sectional view along line II-II of FIG. 1 with a cooking vessel disposed on a subregion of the cooktop defined by an elevation.

### DESCRIPTION OF THE PREFERRED EMBODIMENTS

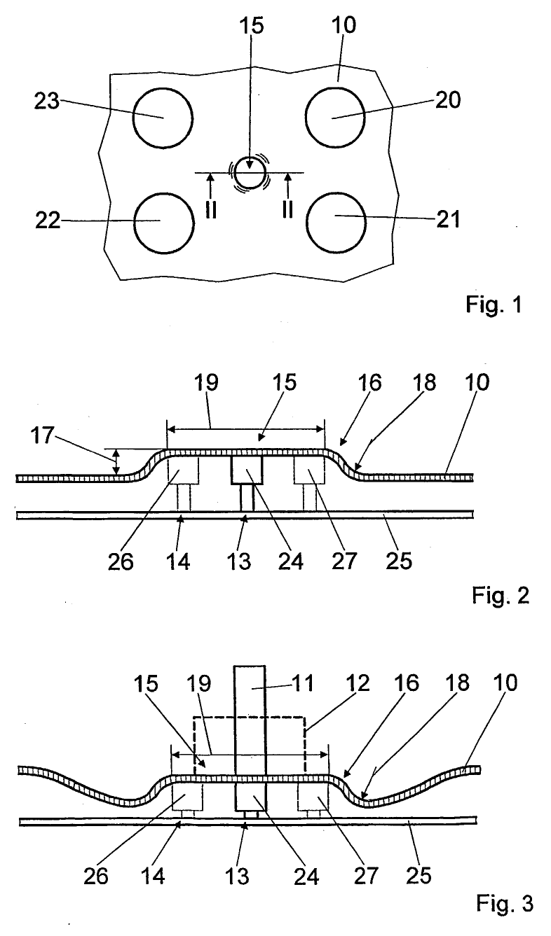

Referring now to the figures of the drawings in detail and first, particularly to FIG. 1 thereof, there is shown, from above, a detail of a cooktop according to the invention having a cooktop panel 10 that is made of glass ceramic material and of which the underside has a plurality of non-illustrated heating elements through which it is possible to heat cooking vessels that can be set down on cooking points 20, 21, 22, 23 of the cooktop. The cooktop also has a weighing unit with a detection unit 13 through which it is possible to determine deformation of the cooktop panel 10 as a result of weight-induced loading. See FIG. 2.

According to the invention, the cooktop panel 10 has a central subregion 15 defined by an elevation 16 (FIGS. 1 and 2), the detection unit 13 making it possible to sense lowering exclusively of the entire subregion 15 as a result of weight-induced loading. The detection unit 13 has a displacement sensor 24 that, by way of an end that is directed toward the cooktop panel 10, is supported on the underside of the latter, in the central region of the subregion 15, and, by way of an end that is directed away from the cooktop panel 10, is supported on a carrier panel 25 that is mounted in a non-illustrated work top, in which the cooktop panel 10 is, likewise, mounted. Instead of a mechanical displacement sensor with contact points, it is also possible to use other sensors that appear expedient to the person skilled in the art, for example, contactless capacitive sensors, etc.

The elevation 16 is integrally formed on the cooktop panel 10 during production of the panel 10, to be precise, the cooktop panel 10 is positioned by way of its underside on a surface with a corresponding elevation. The cooktop panel 10, with the surface, is, then, displaced into a furnace and converted into a free-flowing state by being heated so that, as a result of its own weight, the cooktop panel 10 can adapt itself to the contour of the surface and the elevation 16 can form on the top side of the cooktop panel 10. The subregion 15 is of round configuration with a diameter 19 of 145 mm and a height 17 of 1 mm. Around its border, the elevation 15 has a run-out radius 18 of 80 mm.

If a cooking vessel 11 is positioned on the subregion 15, the entire subregion 15 lowers on account of the weight-induced loading, it being possible for the detection unit 13 to sense the lowering of the entire subregion 15, and to infer the present weight-induced loading from a value determined. The curved border region of the subregion 15 forms a kind of stiffening, with the result that bending of the subregion 15, which is small in comparison with the overall surface area of the cooktop, is negligible. To increase the measuring accuracy further, it is also possible to use a detection unit 14 with displacement sensors 26, 27 disposed on the border region of the subregion 15, as is indicated in FIGS. 2 and 3. A cooking vessel 12 with a larger diameter, but the same weight, as the cooking vessel 11 causes the subregion 15 to be lowered to the same extent.

The cooktop may be configured as a gas cooktop or induction cooktop or a cooktop with different heating systems.

I claim:

1. A cooktop, comprising:
a cooktop panel having a defined subregion;
at least one heating element disposed at said cooktop panel for heating a cooking vessel to be set down on said cooktop panel and apply a weight-induced loading on said cooktop panel; and
a weighing unit having a detection unit disposed at said cooktop panel and determining a deformation of said cooktop panel by sensing a lowering of said subregion as a result of the weight-induced loading.

2. The cooktop according to claim 1, wherein said subregion is defined by at least one elevation.

3. The cooktop according to claim 1, including at least one elevation defining said subregion.

4. The cooktop according to claim 2, wherein said at least one elevation is integrally formed on said cooktop panel.

5. The cooktop according to claim 2, wherein said at least one elevation is integral with said cooktop panel.

6. The cooktop according to claim 2, wherein said at least one elevation is at least one component fastened on said cooktop panel.

7. The cooktop according to claim 2, wherein said at least one elevation has a height of between approximately 0.2 mm and approximately 5 mm.

8. The cooktop according to claim 2, wherein said at least one elevation has a border and a run-out radius of between approximately 20 mm and approximately 100 mm around said border.

9. The cooktop according to claim 7, wherein said at least one elevation has a border and a run-out radius of between approximately 20 mm and approximately 100 mm around said border.

10. The cooktop according to claim 2, wherein said subregion has an area between approximately 78 cm² and approximately 255 cm².

11. The cooktop according to claim 9, wherein said subregion has an area between approximately 78 cm² and approximately 255 cm².

12. The cooktop according to claim 1, wherein said subregion is round.

13. The cooktop according to claim 11, wherein said subregion is round.

14. The cooktop according to claim 1, wherein said cooktop panel is of glass ceramic material.

15. The cooktop according to claim 1, wherein:
said at least one heating element is disposed under said cooktop panel; and
said detection unit is disposed under said cooktop panel.

16. In a cooktop having a cooktop panel with a defined subregion and at least one heating element disposed at the cooktop panel for heating a cooking vessel to be set down thereon and apply a weight-induced loading thereon, a weighing unit comprising:
a detection unit disposed at the cooktop panel and determining a deformation of the cooktop panel by sensing a lowering of the subregion as a result of the weight-induced loading.

17. A process for producing a cooktop, which comprises:
providing a cooktop panel to be formed with at least one integral elevation having a desired contour, the at least one integral elevation defining a subregion, the cooktop panel having a weight;
providing a surface with a contour corresponding to the desired contour;
positioning the cooktop panel on the surface and forming the at least one integral elevation on the cooktop panel by the weight of the cooktop panel;
disposing at least one heating element at the cooktop panel for heating a cooking vessel to be set down on the cooktop panel and to apply a weight-induced loading on the cooktop panel; and
disposing a weighing unit having a detection unit at the cooktop panel and determining a deformation of the cooktop panel with the detection unit by sensing a lowering of the subregion as a result of the weight-induced loading.

18. The process according to claim 17, which further comprises carrying out the positioning and forming step by positioning an underside of the cooktop panel on the contour of the surface.

19. The process according to claim 18, which further comprises carrying out the positioning and forming step by positioning an underside of the cooktop panel on the contour of the surface and then heating at least the cooktop panel.

20. The process according to claim 19, which further comprises carrying out the heating step by heating at least the cooktop panel until the cooktop panel is at least partially converted into a free-flowing state.

21. The process according to claim 20, which further comprises carrying out the converting and forming steps by:
at least partially converting the subregion of the cooktop panel into the free-flowing state; and
adapting the subregion to the contour of the surface to form the at least one elevation during the free-flowing state based upon the weight of the cooktop panel.

22. The process according to claim 20, which further comprises carrying out the forming step by:
at least partially converting the subregion of the cooktop panel into the free-flowing state; and
adapting the subregion to the contour of the surface to form the at least one elevation during the free-flowing state based only upon the weight of the cooktop panel.

23. The process according to claim 21, which further comprises forming the at least one elevation on a top side of the cooktop panel.

24. A process for producing a cooktop, which comprises:
providing a cooktop according to claim 4, the cooktop panel having a weight;
providing a surface with a contour corresponding to a desired contour of the at least one integral elevation; and
forming the at least one integral elevation on the cooktop panel by positioning the cooktop panel on the surface to form the at least one integral elevation by the weight of the cooktop panel.

25. The process according to claim 24, which further comprises carrying out the positioning and forming step by positioning an underside of the cooktop panel on the contour of the surface.

26. The process according to claim 25, which further comprises carrying out the positioning and forming step by positioning an underside of the cooktop panel on the contour of the surface and then heating at least the cooktop panel.

27. The process according to claim 26, which further comprises carrying out the heating step by heating at least the cooktop panel until the cooktop panel is at least partially converted into a free-flowing state.

28. The process according to claim 27, which further comprises carrying out the converting and forming steps by:
at least partially converting the subregion of the cooktop panel into the free-flowing state; and
adapting the subregion to the contour of the surface to form the at least one elevation during the free-flowing state based upon the weight of the cooktop panel.

29. The process according to claim 27, which further comprises carrying out the forming step by:
at least partially converting the subregion of the cooktop panel into the free-flowing state; and
adapting the subregion to the contour of the surface to form the at least one elevation during the free-flowing state based only upon the weight of the cooktop panel.

30. The process according to claim 28, which further comprises forming the at least one elevation on a top side of the cooktop panel.
